(19) United States
(12) Patent Application Publication
(10) Pub. No.: US 2025/0336588 A1
(43) Pub. Date: Oct. 30, 2025

(54) INDUCTOR COMPONENT AND BUCK CONVERTER

(71) Applicant: Murata Manufacturing Co., Ltd., Kyoto-fu (JP)

(72) Inventors: Yoshimasa YOSHIOKA, Nagaokakyo-shi (JP); Kenji TOYOSHIMA, Nagaokakyo-shi (JP); Taiga KATO, Nagaokakyo-shi (JP)

(73) Assignee: Murata Manufacturing Co., Ltd., Kyoto-fu (JP)

(21) Appl. No.: 19/084,282

(22) Filed: Mar. 19, 2025

(30) Foreign Application Priority Data
Apr. 25, 2024 (JP) 2024-071784

(51) Int. Cl. H01F 27/28; H01F 27/02; H01F 27/24; H01F 27/29

(52) U.S. Cl. CPC H01F 27/2804; H01F 27/02; H01F 27/24; H01F 27/29

(57) ABSTRACT

An inductor component includes a first inductor wiring that extends along a first virtual plane and around a first turning axis along a first direction intersecting with the first virtual plane, a second inductor wiring that extends along a second virtual plane parallel and adjacent to the first virtual plane and around a second turning axis along the first direction, and an element body that includes a magnetic material, and the first and second inductor wirings. The magnetic material includes a first magnetic portion in a region closer to the first turning axis than the first inductor wiring, and a second magnetic portion in a region closer to the second turning axis than the second inductor wiring. The first magnetic portion and the second magnetic portion match each other when viewed along the first direction. The first and second turning axes are spaced from each other.

### CROSS-REFERENCE TO RELATED APPLICATION

This application claims benefit of priority to Japanese Patent Application No. 2024-071784, filed Apr. 25, 2024, the entire content of which is incorporated herein by reference.

### BACKGROUND

### Technical Field

The present disclosure relates to an inductor component and a buck converter including the inductor component.

### Background Art

Japanese Unexamined Patent Application Publication No. 2023-148899 discloses a coil component including a magnetic support layer, a first coil pattern disposed on a first main surface of the magnetic support layer, and a second coil pattern disposed on a second main surface of the magnetic support layer.

### SUMMARY

The coil component of Japanese Unexamined Patent Application Publication No. 2023-148899 has room for improvement in terms of improving the acquisition efficiency of an inductance.

Accordingly, the present disclosure provides an inductor component and a buck converter capable of improving the acquisition efficiency of the inductance.

An aspect of the present disclosure provides an inductor component including a first inductor wiring that extends along a first virtual plane and that is located around a first turning axis along a first direction intersecting with the first virtual plane; a second inductor wiring that extends along a second virtual plane parallel and adjacent to the first virtual plane and that is located around a second turning axis along the first direction; and an element body that includes a magnetic material and in which the first inductor wiring and the second inductor wiring are located. The magnetic material includes a first magnetic portion that is located in a region closer to the first turning axis than the first inductor wiring, and a second magnetic portion that is located in a region closer to the second turning axis than the second inductor wiring. The first magnetic portion and the second magnetic portion are formed to match each other when viewed along the first direction, and the first turning axis and the second turning axis are located with spacing from each other in a second direction intersecting with the first direction.

Another aspect of the present disclosure provides a buck converter including: a package substrate formed to be connectable to a semiconductor module; and the inductor component according to the above-described aspect that is located inside the package substrate, in which the inductor component includes an external terminal that is provided on an outer surface of the element body intersecting with the first direction and facing the semiconductor module, in a state in which the semiconductor module is connected to the package substrate.

With the inductor component and the buck converter according to the above-described aspect, the acquisition efficiency of the inductance can be improved.

### BRIEF DESCRIPTION OF THE DRAWINGS

FIG. 1 is a plan view illustrating an inductor component according to an aspect of the present disclosure;

FIG. 2 is a cross-sectional view taken along a line II-II of FIG. 1;

FIG. 3 is a schematic plan view illustrating layers of a first inductor wiring and a third inductor wiring of the inductor component of FIG. 1;

FIG. 4 is a schematic plan view illustrating layers of a second inductor wiring and a fourth inductor wiring of the inductor component of FIG. 1;

FIG. 5 is a first view illustrating an example of a manufacturing method for the inductor component of FIG. 1;

FIG. 6 is a second view illustrating the example of the manufacturing method for the inductor component of FIG. 1;

FIG. 7 is a third view illustrating the example of the manufacturing method for the inductor component of FIG. 1;

FIG. 8 is a fourth view illustrating the example of the manufacturing method for the inductor component of FIG. 1;

FIG. 9 is a fifth view illustrating the example of the manufacturing method for the inductor component of FIG. 1;

FIG. 10 is a sixth view illustrating the example of the manufacturing method for the inductor component of FIG. 1;

FIG. 11 is a seventh view illustrating the example of the manufacturing method for the inductor component of FIG. 1;

FIG. 12 is an eighth view illustrating the example of the manufacturing method for the inductor component of FIG. 1;

FIG. 13 is a ninth view illustrating the example of the manufacturing method for the inductor component of FIG. 1;

FIG. 14 is a tenth view illustrating the example of the manufacturing method for the inductor component of FIG. 1;

FIG. 15 is a circuit diagram illustrating a buck converter including the inductor component of FIG. 1; and

FIG. 16 is a side view illustrating the inductor component of the buck converter of FIG. 15.

### DETAILED DESCRIPTION

Various aspects of the present disclosure will be described.

A first aspect provides an inductor component including: a first inductor wiring that extends along a first virtual plane and that extends around a first turning axis along a first direction intersecting with the first virtual plane; a second inductor wiring that extends along a second virtual plane parallel and adjacent to the first virtual plane and that extends around a second turning axis along the first direction; and an element body that includes a magnetic material and in which the first inductor wiring and the second inductor wiring are located. The magnetic material includes a first magnetic portion that is located in a region closer to the first turning axis than the first inductor wiring, and a second magnetic portion that is located in a region closer to the second turning axis than the second inductor wiring. The first magnetic portion and the second magnetic portion are formed to match each other when viewed along the first direction, and the first turning axis and the second turning axis are located with spacing from each other in a second direction intersecting with the first direction.

A second aspect provides the inductor component according to the first aspect, in which the first magnetic portion and the second magnetic portion are formed of a composite material of a metal magnetic alloy containing a largest amount of an iron element and an organic resin.

A third aspect provides the inductor component according to the first or second aspect, in which in a case in which both ends of the first inductor wiring in a direction in which the first inductor wiring extends are defined as a first end portion and a second end portion, and both ends of the second inductor wiring in a direction in which the second inductor wiring extends are defined as a third end portion and a fourth end portion, the first end portion and the third end portion are electrically isolated of each other, and the second end portion and the fourth end portion are electrically connected to each other.

A fourth aspect provides the inductor component according to the third aspect, further including: an external terminal that is provided on an outer surface of the element body intersecting with the first direction; a vertical wiring that connects the fourth end portion and the external terminal to each other; and a via conductor that connects the second end portion and the fourth end portion to each other.

A fifth aspect provides the inductor component according to any one of the first to fourth aspects, in which an outer shape of the first inductor wiring and an outer shape of the second inductor wiring match each other when viewed along the first direction.

A sixth aspect provides the inductor component according to any one of the first to fifth aspects, in which a turning direction of the first inductor wiring extending around the first turning axis is opposite to a turning direction of the second inductor wiring extending around the second turning axis.

A seventh aspect provides the inductor component according to any one of the first to sixth aspects, in which the first inductor wiring has a spiral shape having the number of turns larger than one, the element body has, inside, a first region closer to the first turning axis than the first inductor wiring. The first magnetic portion and a non-magnetic material are located in the first region, and the first magnetic portion is adjacent to a portion including a largest number of the first inductor wirings when viewed along the second direction from the first turning axis.

An eighth aspect provides the inductor component according to the seventh aspect, in which the non-magnetic material includes a photosensitive insulating material.

A ninth aspect provides the inductor component according to the seventh or eighth aspect, in which the non-magnetic material extends along the first inductor wiring, and in a case in which, when viewed along the first direction, a dimension of the non-magnetic material in a direction orthogonal to a direction in which the non-magnetic material extends is defined as a width of the non-magnetic material, and a dimension of the first inductor wiring in a direction orthogonal to a direction in which the first inductor wiring extends is defined as a width of the first inductor wiring, a maximum value of the width of the non-magnetic material is larger than a maximum value of the width of the first inductor wiring.

A tenth aspect provides the inductor component according to the third aspect, further including a first external terminal, a second external terminal, and a third external terminal that are each provided on an outer surface of the element body intersecting with the first direction. The first external terminal is electrically connected to the first end portion, the second external terminal is electrically connected to the second end portion and the fourth end portion, the third external terminal is electrically connected to the third end portion, and an area of the second external terminal is larger than areas of the first external terminal and the third external terminal when viewed along the first direction.

An eleventh aspect provides the inductor component according to any one of the first to tenth aspects, further including a first pad portion that extends along the second virtual plane and that is adjacent to the second inductor wiring in an electrically independent state.

A twelfth aspect provides a buck converter including a package substrate; and the inductor component according to the third aspect that is located inside the package substrate, in which the second end portion and the fourth end portion are formed to be connected to a load side.

A thirteenth aspect provides a buck converter including a package substrate formed to be connectable to a semiconductor module; and the inductor component according to any one of the first to eleventh aspects that is located inside the package substrate. The inductor component includes an external terminal that is provided on an outer surface of the element body intersecting with the first direction and facing the semiconductor module, in a state in which the semiconductor module is connected to the package substrate.

A fourteenth aspect provides a buck converter including a package substrate; and the inductor component according to any one of the first to eleventh aspects that is located inside the package substrate. The inductor component includes a third inductor wiring that extends along the first virtual plane and that is located with spacing from the first inductor wiring in the second direction, and an absolute value of inductive coupling factor between the first inductor wiring and the second inductor wiring is larger than an absolute value of inductive coupling factor between the first inductor wiring and the third inductor wiring and is in a range of 0.2 to 0.7.

A fifteenth aspect provides the buck converter according to the thirteenth aspect, in which the inductor component is located inside an outer shape of the semiconductor module when viewed along the first direction.

Hereinafter, embodiments of the present disclosure will be described with reference to the drawings. The following description is not intended to limit the present disclosure, is merely an example, and can be appropriately changed without departing from the gist of the present disclosure. The drawings are schematic, and the ratios of the respective dimensions and the like do not necessarily match the actual values.

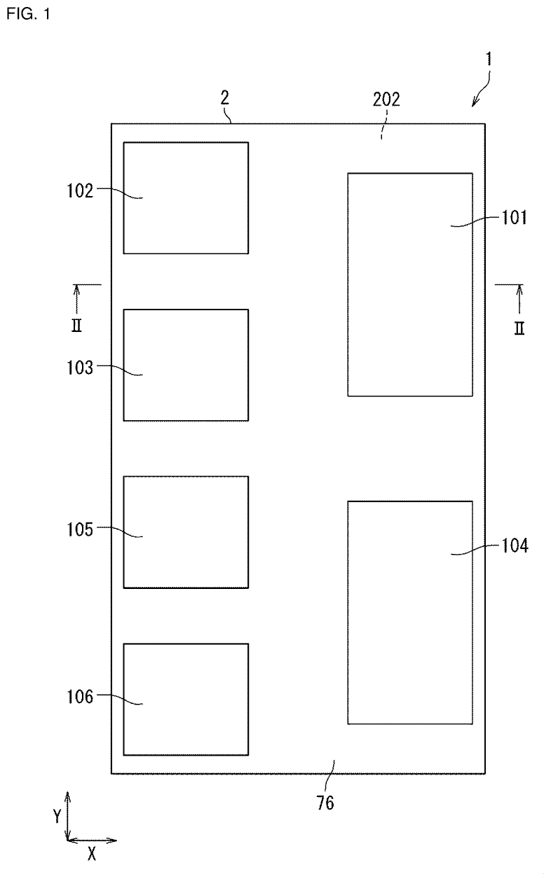

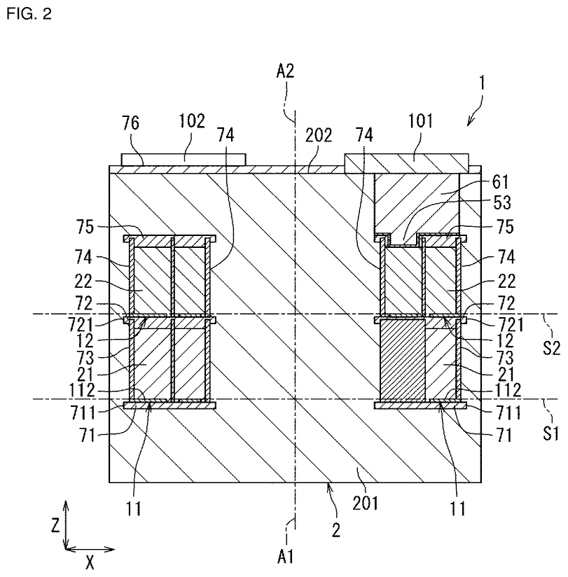

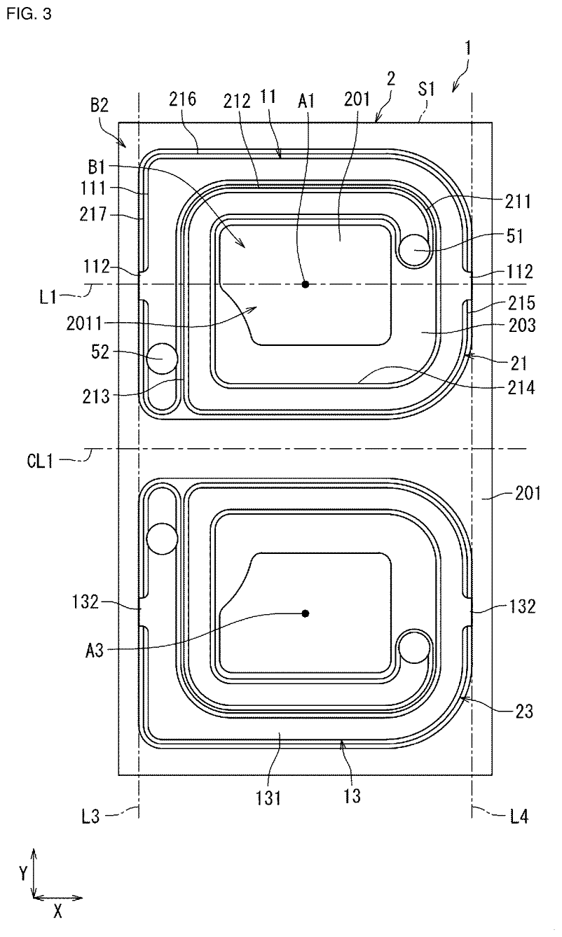

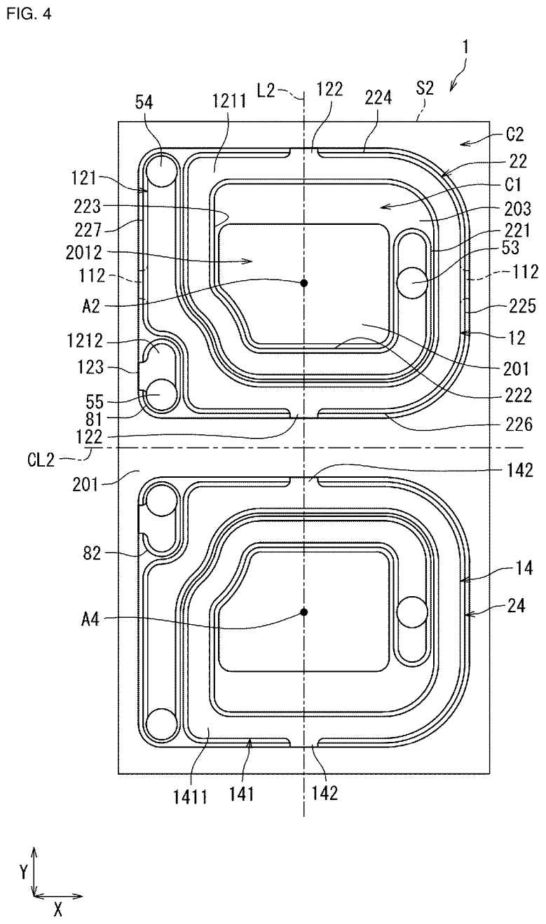

As illustrated in FIGS. 1 and 2, the inductor component 1 of the present disclosure includes a first inductor wiring 21, a second inductor wiring 22, and an element body 2. The first inductor wiring 21 extends along a first virtual plane S1 as illustrated in FIG. 2, and extends (is located) around a first turning axis A1 along a first direction (for example, a Z direction) intersecting with the first virtual plane S1 as illustrated in FIG. 3. The second inductor wiring 22 extends along a second virtual plane S2 parallel and adjacent to the first virtual plane S1 as illustrated in FIG. 2, and extends (is located) around a second turning axis A2 along the first direction Z as illustrated in FIG. 4. As an example, when viewed along the first direction Z, an outer shape of the first inductor wiring 21 and an outer shape of the second inductor wiring 22 match each other (see FIGS. 3 and 4). As illustrated in FIG. 2, the element body 2 includes a magnetic material 201, and the first inductor wiring 21 and the second inductor wiring 22 are located inside the element body 2.

In the present aspect, the inductor component 1 includes a first conductor layer 11 and a second conductor layer 12. The first conductor layer 11 and the second conductor layer 12 are located inside the element body 2. As illustrated in FIG. 2, the first conductor layer 11 is located on the first virtual plane S1. The first inductor wiring 21 is provided on the first conductor layer 11 and extends along the first virtual plane S1. As an example, the first virtual plane S1 is located at a boundary between the first conductor layer 11 and the first inductor wiring 21.

As illustrated in FIG. 2, the second conductor layer 12 is located on the second virtual plane S2 parallel and adjacent to the first virtual plane S1. Here, the second virtual plane S2 parallel and adjacent to the first virtual plane S1 means that the first virtual plane S1 and the second virtual plane S2 are parallel to each other, and the second virtual plane is present at a position separated in a direction orthogonal to the first virtual plane S1. The first inductor wiring 21 is located between the first conductor layer 11 and the second conductor layer 12 in the first direction Z intersecting with the first virtual plane S1 and the second virtual plane S2. The second inductor wiring 22 is provided on the second conductor layer 12 and extends along the second virtual plane S2. The second conductor layer 12 is located between the first inductor wiring 21 and the second inductor wiring 22 in the first direction Z. The second virtual plane S2 is located at a boundary between the second conductor layer 12 and the second inductor wiring 22.

As illustrated in FIGS. 1 to 4, the inductor component 1 includes a third conductor layer 13, a fourth conductor layer 14, a third inductor wiring 23 provided on the third conductor layer 13, and a fourth inductor wiring 24 provided on the fourth conductor layer 14. The third conductor layer 13, the fourth conductor layer 14, the third inductor wiring 23, and the fourth inductor wiring 24 are located inside the element body 2. The third conductor layer 13 is located on the first virtual plane S1 and is electrically isolated of the first conductor layer 11. The fourth conductor layer 14 is located on the second virtual plane S2 and is electrically isolated of the second conductor layer 12. The third inductor wiring 23 extends along the first virtual plane S1. The fourth inductor wiring 24 extends along the second virtual plane S2. The layers of the first inductor wiring 21 and the third inductor wiring 23 are located between the first virtual plane S1 and the second virtual plane S2, and the layers of the second inductor wiring 22 and the fourth inductor wiring 24 are located between the second virtual plane S2 and a main surface 202 of the element body 2 described later.

The element body 2 includes the magnetic material 201, and the first inductor wiring 21 and the second inductor wiring 22 are located inside the element body 2. As an example, the element body 2 has a substantially rectangular parallelepiped shape. As illustrated in FIG. 2, the element body 2 has an outer surface (hereinafter, referred to as the main surface 202) intersecting with the first direction Z. As illustrated in FIG. 1, a plurality of external terminals (six external terminals 101 to 106 in the present aspect) and an insulating layer 76 are provided on the main surface 202. In the present aspect, the second inductor wiring 22 is located closest to the main surface 202 (that is, the external terminal 101) in the first direction Z. Each of the external terminals 101 to 106 is formed of, for example, a multilayer body of Cu/Ni/Au (=5/5/0.1 um).

As illustrated in FIG. 3, when viewed along the first direction Z, the third conductor layer 13 is located symmetrically with respect to the first conductor layer 11 with a first center line CL1, which extends on the first virtual plane S1 in a lateral direction (for example, an X direction) of the inductor component 1, interposed therebetween, and has a shape symmetrical with respect to the first conductor layer 11 with the first center line CL1 interposed therebetween. The third inductor wiring 23 is located symmetrically with respect to the first inductor wiring 21 with the first center line CL1 interposed therebetween, and has a shape symmetrical with respect to the first inductor wiring 21 with the first center line CL1 interposed therebetween. The third inductor wiring 23 extends around a third turning axis A3 that is located symmetrically with respect to the first turning axis A1 with the first center line CL1 interposed therebetween.

As illustrated in FIG. 4, when viewed along the first direction Z, the fourth conductor layer 14 is located symmetrically with respect to the second conductor layer 12 with a second center line CL2, which extends in the lateral direction X on the second virtual plane S2, interposed therebetween, and has a shape symmetrical with respect to the second conductor layer 12 with the second center line CL2 interposed therebetween. The fourth inductor wiring 24 is located symmetrically with respect to the second inductor wiring 22 with the second center line CL2 interposed therebetween, and has a shape symmetrical with respect to the second inductor wiring 22 with the second center line CL2 interposed therebetween. The fourth inductor wiring 24 extends around a fourth turning axis A4 that is located symmetrically with respect to the second turning axis A2 with the second center line CL2 interposed therebetween.

The first center line CL1 and the second center line CL2 are located substantially at the center in a longitudinal direction (for example, a Y direction) of the inductor component 1 when viewed along the first direction Z.

As illustrated in FIG. 3, the first inductor wiring 21 has, as an example, a spiral shape in which the number of turns is larger than one when viewed along the first direction Z. Vias 51 and 52 are connected to both ends of the first inductor wiring 21 in a direction in which the first inductor wiring 21 extends.

The first inductor wiring 21 includes a first portion 211 to a seventh portion 217.

The first portion 211 extends from an end portion located close to the first turning axis A1 to which the via 51 (an example of a via conductor) is connected, in a direction separated from the first center line CL1 along the longitudinal direction Y. As an example, a portion of the first portion 211 to which the via 51 is connected forms a first output portion (an example of a second end portion).

The second portion 212 extends X from an end portion, which is farther from the first center line CL1, among both ends of the first portion 211 in the longitudinal direction Y, along the lateral direction.

The third portion 213 extends from an end portion, which is farther from the first portion 211, among both ends of the second portion 212 in the lateral direction X in a direction approaching the first center line CL1 along the longitudinal direction Y.

The fourth portion 214 extends from an end portion, which is farther from the second portion 212, among both ends of the third portion 213 in the longitudinal direction Y, in a direction approaching the first portion 211 along the lateral direction X.

The fifth portion 215 extends from an end portion, which is farther from the third portion 213, among both ends of the fourth portion 214 in the lateral direction X in a direction separated from the first center line CL1 along the longitudinal direction Y. The fifth portion 215 is located at a position farther from the first portion 211 than the first turning axis A1 in the lateral direction X, and a part of the fifth portion 215 overlaps with the first portion 211 when viewed from the first turning axis A1 along the lateral direction X. The fifth portion 215 and the first portion 211 are insulated from each other.

The sixth portion 216 extends from an end portion, which is farther from the fourth portion 214, among both ends of the fifth portion 215 in the longitudinal direction Y, in a direction approaching the third portion 213 along the lateral direction X. The sixth portion 216 is located at a position farther from the first turning axis A1 than the second portion 212 in the longitudinal direction Y, and a part of the sixth portion 216 overlaps with the second portion 212 when viewed from the first turning axis A1 along the longitudinal direction Y. The sixth portion 216 and the second portion 212 are insulated from each other.

The seventh portion 217 extends from an end portion, which is farther from the fifth portion 215, among both ends of the sixth portion 216 in the lateral direction X in a direction approaching the first center line CL1 along the longitudinal direction Y. The seventh portion 217 is located at a position farther from the first turning axis A1 than the third portion 213 in the lateral direction X, and a part of the seventh portion 217 overlaps with the third portion 213 when viewed from the first turning axis A1 along the lateral direction X. The seventh portion 217 and the third portion 213 are insulated from each other. The via 52 is connected to an end portion, which is closer to the first center line CL1, among both ends of the seventh portion 217 in the longitudinal direction Y. As an example, a portion of the seventh portion 217 to which the via 52 is connected forms a first input portion (an example of a first end portion).

The first conductor layer 11 includes a first main body portion 111 that is located around the first turning axis A1 and a protruding portion 112 that is provided on the first main body portion 111. In the present aspect, when viewed along the first direction Z, the first main body portion 111 has substantially the same shape as the first inductor wiring 21, and the entire first main body portion 111 overlaps with the first inductor wiring 21. The protruding portion 112 extends from the first main body portion 111 in a direction separated from the first turning axis A1 along a second direction intersecting with the first direction Z.

As illustrated in FIG. 3, in the present aspect, the first conductor layer 11 includes two protruding portions 112 extending along the lateral direction X. As an example, the two protruding portions 112 are located symmetrically with respect to each other with the first turning axis A1 interposed therebetween. Each protruding portion 112 is provided in a portion of the first main body portion 111 corresponding to the fifth portion 215 (in other words, a portion of the first main body portion 111 overlapping with the fifth portion 215 when viewed along the first direction Z) and a portion of the first main body portion 111 corresponding to the seventh portion 217 (in other words, a portion of the first main body portion 111 overlapping with the seventh portion 217 when viewed along the first direction Z). A distal end portion, which is farther from the first main body portion 111, among both ends of each protruding portion 112 in the second direction (for example, the lateral direction X) is in contact with the magnetic material 201 of the element body 2. As a result, the corrosion of the first conductor layer 11 can be suppressed. In addition, since the protruding portion 112 is not exposed from the element body 2, the first conductor layer 11 can be isolated in the inductor component 1, and a plurality of inductor wirings that are electrically isolated of each other can be disposed on the same virtual plane. As a result, it is possible to improve the degree of freedom in the design of the inductor component 1. The second direction may be any direction as long as the direction intersects with the first direction, and may be, for example, a direction having components or vectors in both the lateral direction X and the longitudinal direction Y, in addition to the lateral direction X or the longitudinal direction Y.

The phrase “in contact with the magnetic material 201” means being in contact with apart of a material forming the magnetic material 201. In a case in which the magnetic material 201 is formed of, for example, a composite body of a resin and an inorganic filler (for example, a composite body of epoxy and FeSiCr), a distal end portion of the first main body portion 111 is in contact with at least one of the resin and the inorganic filler of the magnetic material 201. The resin contained in the magnetic material 201 includes, for example, epoxy, acryl, a liquid crystal polymer, phenol, and a combination thereof, and is responsible for the strength of the element body 2 and a good insulating property. The inorganic filler contained in the magnetic material 201 includes, for example, a metal magnetic powder (for example, a powder containing, as a main component, an Fe element such as an Fe, FeSi-based, FeSiCr-based, or FeNi-based powder). The magnetic material 201 in this case has a high magnetic permeability and a high magnetism saturation density. The inorganic filler does not need to be a single type of magnetic powder, and may be a magnetic powder in which different compositions and different particle diameters are combined, or may contain an insulating filler such as silica to ensure a coefficient of linear expansion and the insulating property.

As illustrated in FIG. 3, the element body 2 has, inside, the first region B1 closer to the first turning axis A1 than the first inductor wiring 21 and a second region B2 farther from the first turning axis A1 than the first inductor wiring 21. In the present aspect, the first region B1 is surrounded by the first portion 211 to the fifth portion 215 of the first inductor wiring 21 when viewed along the first direction Z. The magnetic material 201 and a non-magnetic material 203 are located in the first region B1. The magnetic material 201 located in the first region B1 forms a first magnetic portion 2011. The first magnetic portion 2011 has a substantially rectangular shape when viewed along the first direction Z, and is adjacent to a portion (in the present aspect, the first portion 211 to the third portion 213) with which the first inductor wiring 21 overlaps when viewed from the first turning axis A1 along the second direction. In other words, the magnetic material 201 is adjacent to a portion including the largest number of the first inductor wirings 21 when viewed from the first turning axis A1 along the second direction. Here, the phrase “the first magnetic portion 2011 is adjacent to the first inductor wiring 21” means that a width of the non-magnetic material 203 in the second direction, which is present between the first magnetic portion 2011 and the first inductor wiring 21, is equal to or smaller than 25 μm and is equal to or smaller than twice wiring spacing of the adjacent first inductor wiring 21. In FIG. 3, the wiring spacing of the first inductor wiring 21 (for example, spacing between the first portion 211 and the fifth portion 215) is 10 μm, and the width of the non-magnetic material 203 present between the first magnetic portion 2011 and the first inductor wiring 21 (for example, the first portion 211) in the second direction (for example, the lateral direction X) is equal to or smaller than 20 μm. The non-magnetic material 203 is adjacent to a portion (in the present aspect, the fourth portion 214 and the fifth portion 215) with which the first inductor wiring 21 does not overlap and the first magnetic portion 2011 when viewed from the first turning axis A1 along the second direction. Here, the phrase “the non-magnetic material 203 is adjacent to the first inductor wiring 21” means that the first magnetic portion 2011 is not present between the non-magnetic material 203 and the first inductor wiring 21, and the non-magnetic material 203 and the first inductor wiring 21 are in contact with each other. The non-magnetic material 203 of the first region B1 has a substantially C-shape extending along the fourth portion 214 and the fifth portion 215 when viewed along the first direction Z. The non-magnetic material 203 of the first region B1 includes, for example, a photosensitive insulating material. The magnetic material 201 is located over the entire second region B2.

As illustrated in FIG. 4, the second inductor wiring 22 extends around the second turning axis A2 along the first direction Z. In the present aspect, the second inductor wiring 22 has a spiral shape having the number of turns larger than one and being wound in a direction opposite to the first inductor wiring 21 when viewed along the first direction Z. In other words, the first inductor wiring 21 is turned counterclockwise from the inside toward the outside of the first turning axis A1, whereas the second inductor wiring 22 is turned clockwise from the inside toward the outside of the second turning axis A2. That is, a turning direction of the first inductor wiring 21 extending around the first turning axis A1 is opposite to a turning direction of the second inductor wiring 22 extending around the second turning axis A2. Vias 53 and 54 extending in the first direction Z are connected to both ends of the second inductor wiring 22 in a direction in which the second inductor wiring 22 extends. As illustrated in FIG. 2, the via 53 connects the second inductor wiring 22 and a vertical wiring 61 to each other. The vertical wiring 61 connects the second inductor wiring 22 and the external terminal 101 to each other through the via 53. An insulating layer 75 is located between the second inductor wiring 22 and the vertical wiring 61 in the first direction Z.

The second inductor wiring 22 has a first portion 221 to a seventh portion 227.

The first portion 221 extends from an end portion located close to the first turning axis A1 to which the via 53 is connected, in a direction approaching the second center line CL2 along the longitudinal direction Y As an example, a portion of the first portion 221 to which the via 53 is connected forms a second output portion (an example of a fourth end portion). The vias 51 and 53 are adjacent to each other when viewed along the first direction Z. The via 51 connects a portion of the first inductor wiring 21 to which the via 51 is connected and a portion of the second inductor wiring 22 to which the via 53 is connected, to each other. That is, the first output portion and the second output portion are adjacent to each other and are electrically connected to each other. The phrase “the first output portion and the second output portion are adjacent to each other” means, for example, a state in which the vias 51 and 53 are located in a very narrow region (for example, within 20 μm) when viewed along the first direction Z. In the present aspect, the vias 51 and 53 are located at a distance of about 10 μm when viewed along the first direction Z.

The second portion 222 extends from an end portion, which is closer to the second center line CL2, among both ends of the first portion 221 in the longitudinal direction Y, along the lateral direction X.

The third portion 223 extends from an end portion, which is farther from the first portion 221, among both ends of the second portion 222 in the lateral direction X, in a direction separated from the second center line CL2 along the longitudinal direction Y.

The fourth portion 224 extends from an end portion, which is farther from the second portion 222, among both ends of the third portion 223 in the longitudinal direction Y, in a direction approaching the first portion 221 along the lateral direction X.

The fifth portion 225 extends from an end portion, which is farther from the third portion 223, among both ends of the fourth portion 224 in the lateral direction X, in a direction approaching the second center line CL2 along the longitudinal direction Y. The fifth portion 225 is located at a position farther from the second turning axis A2 than the first portion 221 in the lateral direction X, and a part of the fifth portion 225 overlaps with the first portion 221 when viewed from the second turning axis A2 along the lateral direction X. The fifth portion 225 and the first portion 221 are insulated from each other.

The sixth portion 226 extends from an end portion, which is farther from the fourth portion 224, among both ends of the fifth portion 225 in the longitudinal direction Y, in a direction approaching the third portion 223 along the lateral direction X. The sixth portion 226 is located at a position farther from the second portion 222 than the second turning axis A2 in the longitudinal direction Y, and a part of the sixth portion 226 overlaps with the second portion 222 when viewed from the second turning axis A2 along the longitudinal direction Y The sixth portion 226 and the second portion 222 are insulated from each other.

The seventh portion 227 extends from an end portion, which is farther from the fifth portion 225, among both ends of the sixth portion 226 in the lateral direction X, in a direction separated from the second center line CL2 along the longitudinal direction Y. The seventh portion 227 is located at a position farther from the second turning axis A2 than the third portion 223 in the lateral direction X, and a part of the seventh portion 227 overlaps with the third portion 223 when viewed from the second turning axis A2 along the lateral direction X. The seventh portion 227 and the third portion 223 are insulated from each other. The via 54 is connected to an end portion, which is closer to the second center line CL2, among both ends of the seventh portion 227 in the longitudinal direction Y As an example, a portion of the seventh portion 227 to which the via 54 is connected forms a second input portion (an example of a third end portion). As illustrated in FIGS. 3 and 4, when viewed along the first direction Z, the vias 52 and 54 are located with spacing from each other in the longitudinal direction Y That is, the first input portion and the second input portion are located at positions separated from each other in the second direction (for example, the longitudinal direction Y) and are not connected to each other inside the element body 2 through the vias or the like, that is, the first input portion and the second input portion are electrically isolated of each other. Since the vias 52 and 54 are located at positions separated from each other by a distance of 200 μm or more (for example, 500 μm) when viewed along the first direction Z, the first input portion and the second input portion can be separated from each other.

The second conductor layer 12 includes a second main body portion 121 that is located around the second turning axis A2 and a protruding portion 122 that is provided on the second main body portion 121. When viewed along the first direction Z, the second main body portion 121 has a turning portion 1211 that has substantially the same shape as the second inductor wiring 22 and a non-turning portion 1212 that is adjacent to the turning portion 1211 in an electrically isolated state. In the present aspect, the entire turning portion 1211 overlaps with the second inductor wiring 22 when viewed along the first direction Z. When viewed along the first direction Z, the non-turning portion 1212 has an elongated circular shape that extends along the longitudinal direction Y and is adjacent to a portion in which the sixth portion 226 and the seventh portion 227 of the second inductor wiring 22 are connected to each other.

The via 55 is connected to an end portion, which is closer to the second center line CL2, among both ends of the non-turning portion 1212 in the longitudinal direction Y. A protruding portion 123 is provided at the center of the non-turning portion 1212 in the longitudinal direction Y. The protruding portion 123 extends from the non-turning portion 1212 in a direction separated from the second turning axis A2 in the lateral direction X. A distal end portion, which is farther from the non-turning portion 1212, among both ends of the protruding portion 123 in the lateral direction X is in contact with the magnetic material 201 of the element body 2.

As illustrated in FIG. 4, in the present aspect, the second conductor layer 12 includes two protruding portions 122 that extend from the second main body portion 121 (in the present aspect, the turning portion 1211) along the longitudinal direction Y. As an example, the two protruding portions 122 are located symmetrically with respect to each other with the second turning axis A2 interposed therebetween. Each protruding portion 122 is provided in a portion of the second main body portion 121 corresponding to the fourth portion 224 (in other words, a portion of the second main body portion 121 overlapping with the fourth portion 224 when viewed along the first direction Z) and a portion of the second main body portion 121 corresponding to the sixth portion 226 (in other words, a portion of the second main body portion 121 overlapping with the sixth portion 226 when viewed along the first direction Z). That is, the protruding portion 122 is located at a position not overlapping with the protruding portion 112 when viewed along the first direction Z. As a result, it is possible to achieve the inductor component 1 capable of improving the short-circuit resistance (interlayer short-circuit resistance) between the first inductor wiring 21 that is located on the first virtual plane S1 and the second inductor wiring 22 that is located on the second virtual plane S2 parallel and adjacent to the first virtual plane S1. In addition, since the protruding portion 112 and the protruding portion 122 are provided, the power can be supplied through the insulating layer, and thus the first inductor wiring 21 and the second inductor wiring 22 can be formed by plating growth. In the plating growth (for example, an electrolytic plating method), the first conductor layer 11 and the second conductor layer 12 having a very high purity can be formed, and thus the first inductor wiring 21 and the second inductor wiring 22 having high conductivity can be formed. As a result, the direct current electrical resistance of the inductor component 1 can be decreased. A distal end portion, which is farther from the second main body portion 121, among both ends of each protruding portion 122 in the second direction (for example, the longitudinal direction Y) is in contact with the magnetic material 201 of the element body 2.

As illustrated in FIG. 4, the element body 2 has, inside, the first region C1 closer to the second turning axis A2 than the second inductor wiring 22 and a second region C2 farther from the second turning axis A2 than the second inductor wiring 22. In the present aspect, the first region C1 is surrounded by the first portion 221 to the fifth portion 225 of the second inductor wiring 22 when viewed along the first direction Z. The magnetic material 201 and the non-magnetic material 203 are located in the first region C1. The magnetic material 201 located in the first region C1 forms a second magnetic portion 2012. The second magnetic portion 2012 has a substantially rectangular shape when viewed along the first direction Z, and is adjacent to a portion (in the present aspect, the first portion 221 to the third portion 223) with which the second inductor wiring 22 overlaps when viewed from the second turning axis A2 along the second direction. In other words, the magnetic material 201 is adjacent to a portion including the largest number of the second inductor wirings 22 when viewed from the second turning axis A2 along the second direction. Here, the phrase “the second magnetic portion 2012 is adjacent to the second inductor wiring 22” means that a width of the non-magnetic material 203 in the second direction, which is present between the second magnetic portion 2012 and the second inductor wiring 22, is equal to or smaller than 25 μm and is equal to or smaller than twice wiring spacing of the adjacent second inductor wiring 22. In FIG. 4, the wiring spacing of the second inductor wiring 22 (for example, spacing between the first portion 221 and the fifth portion 225) is 10 μm, and the width of the non-magnetic material 203 present between the second magnetic portion 2012 and the second inductor wiring 22 (for example, the first portion 221) in the second direction (for example, the lateral direction X) is equal to or smaller than 20 μm. The non-magnetic material 203 is adjacent to a portion (in the present aspect, the fourth portion 224 and the fifth portion 225) with which the first inductor wiring 21 does not overlap and the second magnetic portion 2012 when viewed from the second turning axis A2 along the second direction. Here, the phrase “the non-magnetic material 203 is adjacent to the second inductor wiring 22” means that the second magnetic portion 2012 is not present between the non-magnetic material 203 and the second inductor wiring 22, and the non-magnetic material 203 and the second inductor wiring 22 are in contact with each other. The non-magnetic material 203 of the first region C1 extends in a substantially linear shape along the fourth portion 224 when viewed along the first direction Z. The non-magnetic material 203 of the first region C1 includes, for example, a photosensitive insulating material. The magnetic material 201 is located over the entire second region B2.

As illustrated in FIGS. 3 and 4, the first magnetic portion 2011 and the second magnetic portion 2012 are formed to match each other when viewed along the first direction Z. The first turning axis A1 and the second turning axis A2 are located with spacing from each other in the second direction (for example, the longitudinal direction Y). The first turning axis A1 and the second turning axis A2 are located at the center with respect to the outer shapes of the first regions B1 and C1 as an example, but the configuration is not limited to this. The first turning axis A1 and the second turning axis A2 need only be disposed such that the centroid of the first inductor wiring 21 and the centroid of the second inductor wiring 22 are located at different positions. For example, the first turning axis A1 may be located at the center of the outer shape of the first inductor wiring 21, and the second turning axis A2 may be located at the center of an inner shape of the second inductor wiring 22.

The first magnetic portion 2011 and the second magnetic portion 2012 are formed of, as an example, a composite material of a metal magnetic alloy containing the largest amount of iron element and an organic resin. The metal magnetic alloy is, for example, an alloy in which the Fe element, such as FeSiCr and FeSiNbCu, has the maximum element ratio. By dispersing the metal magnetic alloy in, for example, an epoxy resin, the metal magnetic alloy is insulated, and an eddy current is suppressed, so that a magnetic material having a low loss is obtained. The first magnetic portion 2011 and the second magnetic portion 2012 may be formed of a material other than the composite material having the configuration described above.

As illustrated in FIGS. 1 to 4, the external terminal 103 (an example of a first external terminal) is electrically connected to a portion (an example of a first end portion) to which the via 52 of the first inductor wiring 21 is connected. The external terminal 101 (an example of a second external terminal) is electrically connected to a portion (an example of a second end portion) to which the via 51 of the first inductor wiring 21 is connected and a portion (an example of a fourth end portion) to which the via 53 of the second inductor wiring 22 is connected. The external terminal 102 (an example of a third external terminal) is electrically connected to a portion (an example of a third end portion) to which the via 54 of the second inductor wiring 22 is connected. When viewed along the first direction Z, an area of the external terminal 101 is larger than areas of the external terminals 102 and 103.

As illustrated in FIG. 3, a virtual straight line connecting the first turning axis A1 and the center of the protruding portion 112 in a direction (for example, the longitudinal direction Y) intersecting with the second direction to each other is defined as a first virtual straight line L1. As illustrated in FIG. 4, a virtual straight line connecting the second turning axis A2 and the center of the protruding portion 122 in a direction (for example, the lateral direction X) intersecting with the third direction to each other is defined as a second virtual straight line L2. The inductor component 1 is formed such that the first virtual straight line L1 and the second virtual straight line L2 form an angle of 80 degrees to 110 degrees. As a result, the interlayer short-circuit resistance can be more reliably improved.

As illustrated in FIG. 4, the inductor component 1 includes a first pad portion 81 and a second pad portion 82 that are located on the second virtual plane S2. The first pad portion 81 is located to overlap with the non-turning portion 1212 of the second conductor layer 12 when viewed along the first direction Z. The first pad portion 81 is electrically isolated of the second inductor wiring 22. The first pad portion 81 and the second pad portion 82 are located symmetrically with respect to each other with the second center line CL2 interposed therebetween, and have a shape symmetrical with respect to each other with the second center line CL2 interposed therebetween.

As illustrated in FIG. 2, the inductor component 1 includes an insulating layer 71 and an insulating layer 72 that are located inside the element body 2. The insulating layer 71 is provided on the first conductor layer 11 and is located on a side opposite to the first inductor wiring 21 with respect to the first conductor layer 11 in the first direction Z. The insulating layer 72 is provided on the second conductor layer 12 and is located on a side opposite to the second inductor wiring 22 with respect to the second conductor layer 12 in the first direction Z. The protruding portion 112 is located closer to the first turning axis A1 than an end portion of the insulating layer 71 in the second direction (for example, an end portion 711 in the lateral direction X illustrated in FIG. 2) when viewed along the first direction Z. The protruding portion 122 is located closer to the second turning axis A2 than an end portion of the insulating layer 72 in the second direction (for example, an end portion in the longitudinal direction Y, which is not illustrated) when viewed along the first direction Z. As a result, since the insulation between the first inductor wiring 21 and the second inductor wiring 22 can be ensured, the degree of freedom in the design of the inductor component 1 can be improved.

As an example, the first conductor layer 11 has a thickness that is a dimension in the first direction Z of smaller than 1.0 μm. The thickness of the first conductor layer 11 is smaller than 1/100 of the thickness of the first inductor wiring 21. The second conductor layer 12 may also be formed in the same manner as the first conductor layer 11. That is, the second conductor layer 12 may be formed to have a thickness of smaller than 1.0 μm and smaller than 1/100 of the thickness of the second inductor wiring 22. As a result, the first conductor layer 11 is also sufficiently thin with respect to the first inductor wiring 21, and thus the resistance of the first inductor wiring 21 is dominant instead of the resistance of the first conductor layer 11. As a result, the selectivity of the metal material forming the first conductor layer 11 is improved. In addition, since the thickness of the first conductor layer 11 itself is sufficiently small, the interlayer short-circuit through the first conductor layer 11 can be suppressed. For example, in a case in which the first conductor layer 11 is Ti/Cu that is vapor-deposited by sputtering, Ti is formed to have a thickness of 30 nm, and Cu is formed to have a thickness of 800 nm. The first conductor layer 11 can be formed by an electroless plating method, a printing method, and the like, in addition to sputtering. For example, Au, Ag, or A1 can be used as a material for the first conductor layer 11.

As an example, the first conductor layer 11 and the second conductor layer 12 each include a single layer (Cu or Ag) or a plurality of layers (for example, Ti/Cu) laminated along the first direction Z. In a case in which each of the first conductor layer 11 and the second conductor layer 12 includes the plurality of layers laminated along the first direction Z, the degree of freedom in the design of the inductor component 1 can be increased, so that the cost reduction can be achieved without impairing a quality of the inductor component 1. For example, the number of layers forming each conductor layer can be optionally set depending on each layer. For example, by forming the first conductor layer 11 such that two layers (Ti/Cu) are included and the second conductor layer 12 such that two layers (Cu) are included, the close-contact strength of the first conductor layer 11 to the resin can be improved, and the close-contact strength of the second conductor layer 12 to copper (sacrificial copper) can be increased.

As illustrated in FIG. 2, the inductor component 1 includes an insulating layer 73 located inside the element body 2. The insulating layer 73 extends from the protruding portion 112 toward the second virtual plane S2 along the first direction Z. The dimension (=thickness) of the insulating layer 73 in the first direction Z is larger than the thickness of the first inductor wiring 21. As a result, the insulation between a first layer including the first conductor layer 11 and the first inductor wiring 21 and a second layer including the second conductor layer 12 and the second inductor wiring 22 can be reliably ensured. The inductor component 1 may include an insulating layer (not illustrated) that extends from the protruding portion 122 in a direction separated from the first virtual plane S1 along the first direction Z and that has a thickness larger than the thickness of the second inductor wiring 22.

As illustrated in FIG. 2, the inductor component 1 includes the external terminal 101, the vertical wiring 61 located inside the element body 2, and an insulating layer 74. As described above, the external terminal 101 is provided on the main surface 202. The vertical wiring 61 extends in the first direction Z and connects the second inductor wiring 22 and the external terminal 101 to each other in a state of being in contact with the magnetic material 201 of the element body 2 in the second direction. The insulating layer 74 is located between the second inductor wiring 22 and the magnetic material 201 of the element body 2. Since the vertical wiring 61 is a wiring for connection to the external terminal 101, the insulating property can be ensured even without the insulating layer. Therefore, since the step of forming the insulating layer on the vertical wiring 61 is not necessary, the manufacturing cost of the inductor component 1 can be reduced. The vertical wiring 61 is not limited to being connected to the second inductor wiring 22 through the via 53, and may be directly connected to the second inductor wiring 22. In addition, the vertical wiring 61 may be connected to the second inductor wiring 22 through the seed layer or a layer necessary for forming the vertical wiring 61, in addition to the via 53.

As an example, as illustrated in FIG. 3, the protruding portion 112 of the first conductor layer 11 and the protruding portion 132 (an example of a third protruding portion) of the third conductor layer 13 are located on the same virtual straight lines L3 and L4. As illustrated in FIG. 4, the protruding portion 122 of the second conductor layer 12 and a protruding portion 142 of the fourth conductor layer 14 are located on the same virtual straight line L2. As a result, the inductor component 1 in which the plurality of inductor wirings that are electrically isolated of each other are disposed on the same virtual plane can be achieved.

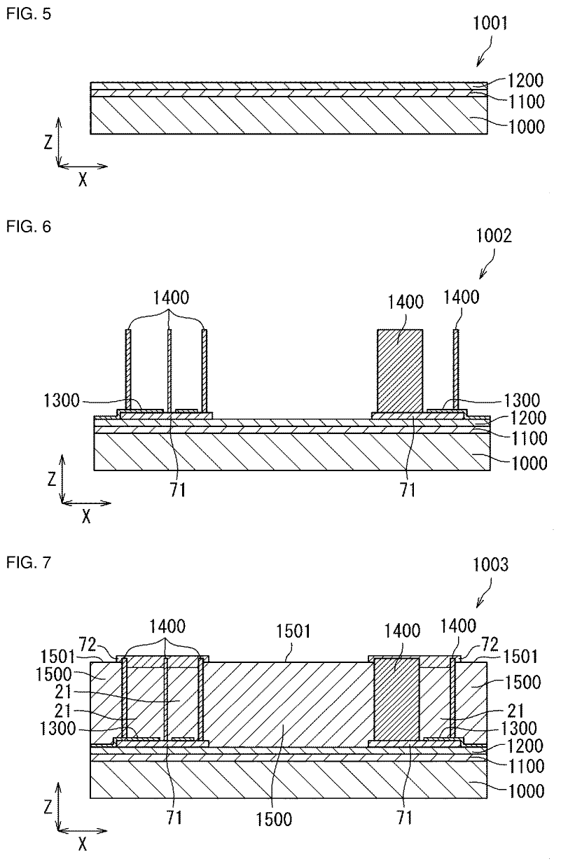

An example of a manufacturing method for the inductor component 1 will be described with reference to FIGS. 5 to 14. In the following description, the third conductor layer 13, the fourth conductor layer 14, the third inductor wiring 23, and the fourth inductor wiring 24 will not be described. FIGS. 5 to 14 are views corresponding to cross sections taken along a line II-II of FIG. 1. In the manufacturing method illustrated in FIGS. 5 to 14, for example, a part or all of the steps are automatically performed by using a manufacturing apparatus for the inductor component 1.

As illustrated in FIGS. 5 and 6, the manufacturing apparatus forms the insulating layer 71 on a first multilayer body 1001 in which an adhesive layer 1100 and a seed layer (conductor) 1200 are laminated on a substrate 1000, and then forms a pattern seed 1300 extending over the insulating layer 71 and the seed layer 1200 and a permanent resist 1400 to form a second multilayer body 1002. The pattern seed 1300 forms the first conductor layer 11. The insulating layer 71 is formed by, for example, a step including lamination of insulating layers, photolithography, and solidification. The pattern seed 1300 is formed by, for example, a step including sputtering (seed formation), resist lamination, photolithography, seed etching, and resist peeling. The permanent resist 1400 is formed by, for example, a step including permanent resist coating, photolithography, and solidification. A part of the permanent resist 1400 forms the non-magnetic material 203 and the insulating layer 73.

As illustrated in FIG. 7, the manufacturing apparatus simultaneously forms the first inductor wiring 21 and sacrificial copper 1500 on the second multilayer body 1002, and then forms the insulating layer 72 on the first inductor wiring 21. The first inductor wiring 21 and the sacrificial copper 1500 are formed by, for example, a step including electric field plating (for example, electric field copper plating). The insulating layer 72 is formed by, for example, a step including insulating layer lamination, photolithography, and solidification. In this case, a magnetic path cavity 1501 and the vias 51 and 52 are simultaneously formed during the photolithography step.

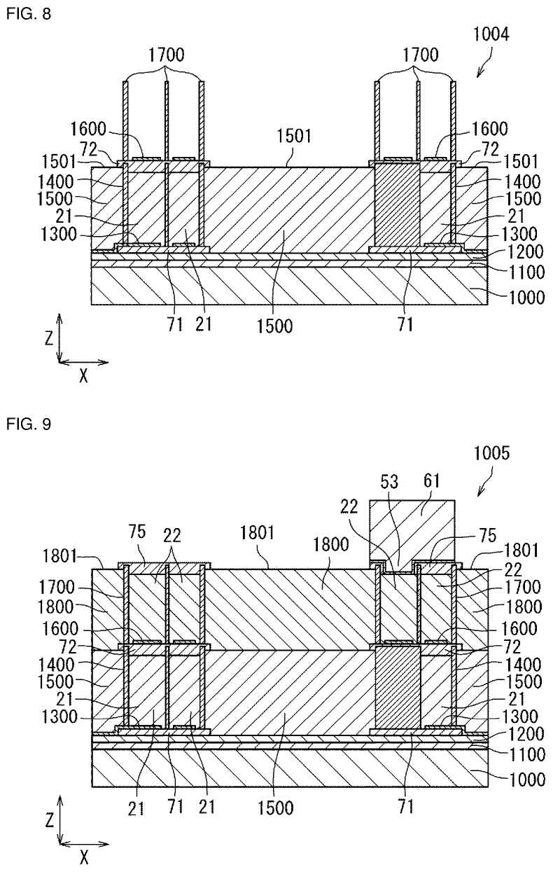

As illustrated in FIG. 8, the manufacturing apparatus forms a pattern seed 1600 and a permanent resist 1700 located on the insulating layer 72 on a third multilayer body 1003 to form a fourth multilayer body 1004. The pattern seed 1600 forms the second conductor layer 12. The pattern seed 1600 is formed by, for example, a step including sputtering (seed formation), resist lamination, photolithography, seed etching, and resist peeling. The permanent resist 1700 is formed by a step including permanent resist lamination, photolithography, and solidification. A part of the permanent resist 1700 forms the insulating layer 74.

The pattern seed 1600 may be formed of the same material as the pattern seed 1300 of the second multilayer body 1002, or may be formed of a material different from the pattern seed 1300. The pattern seeds 1300 and 1600 are formed by selecting the optimal material in each layer. For example, by forming the pattern seed 1300 of the first layer with a conductive material containing Ti, the close-contact strength to the insulating layer 71 and the seed layer 1200 can be improved. By forming the pattern seed 1600 of the second layer with the same conductive material (for example, only Cu) as the second inductor wiring 22, the connectivity with the vias 53 and 54 can be improved.

As illustrated in FIG. 9, the manufacturing apparatus simultaneously forms the second inductor wiring 22 and sacrificial copper 1800 on the fourth multilayer body 1004, forms the insulating layer 75 on the second inductor wiring 22, and then forms the vertical wiring 61 on the insulating layer 75 to form a fifth multilayer body 1005. The second inductor wiring 22 and the sacrificial copper 1800 are formed by, for example, a step including electric field plating (for example, electric field copper plating). The insulating layer 75 is formed by a step including insulating layer lamination, photolithography, and solidification. In this case, a magnetic path cavity 1801 and the vias 53 and 54 are simultaneously formed during the photolithography step. The vertical wiring 61 is formed by, for example, a step of sputtering (seed formation on the entire surface), laminating a resist, photolithography, electrolytic plating, resist peeling, and seed etching.

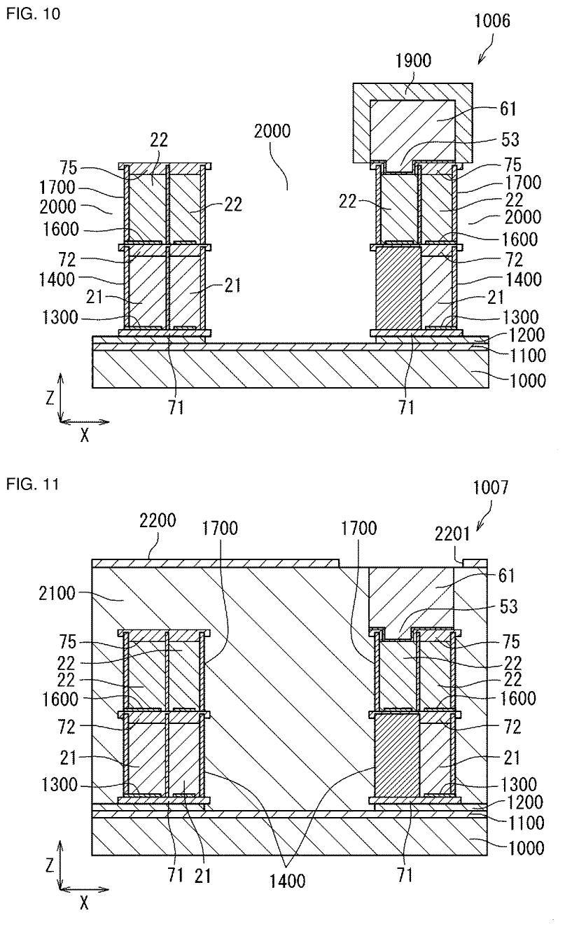

As illustrated in FIG. 10, the manufacturing apparatus forms a protective layer 1900 on the vertical wiring 61 on the fifth multilayer body 1005, removes the sacrificial copper 1500 and 1800 to form a magnetic path hole 2000, and then forms a sixth multilayer body 1006. The protective layer 1900 is formed by, for example, a step including resist lamination and photolithography. The removal of the sacrificial copper 1500 and 1800 is performed by, for example, etching. In a case in which the pattern seed 1300 of the first layer contains Ti, after Cu etching, Ti etching is performed, and a part of the seed layer 1200 remains.

As illustrated in FIG. 11, the manufacturing apparatus removes the protective layer 1900 of the sixth multilayer body 1006, forms a magnetic layer 2100, and then forms a solder resist (insulating layer) 2200 on the magnetic layer 2100 to form a seventh multilayer body 1007. The protective layer 1900 is removed by, for example, a step including resist peeling. The magnetic layer 2100 is formed by, for example, a step including magnetic material pressing, solidification, and grinding. The vertical wiring 61 is exposed to the outside by grinding. The magnetic layer 2100 forms a part of the magnetic material 201. The solder resist 2200 is formed by, for example, a step including solder resist lamination, photolithography, and solidification. A cavity 2201 through which the vertical wiring 61 is exposed to the outside is formed in the solder resist 2200. The solder resist 2200 forms the insulating layer 76.

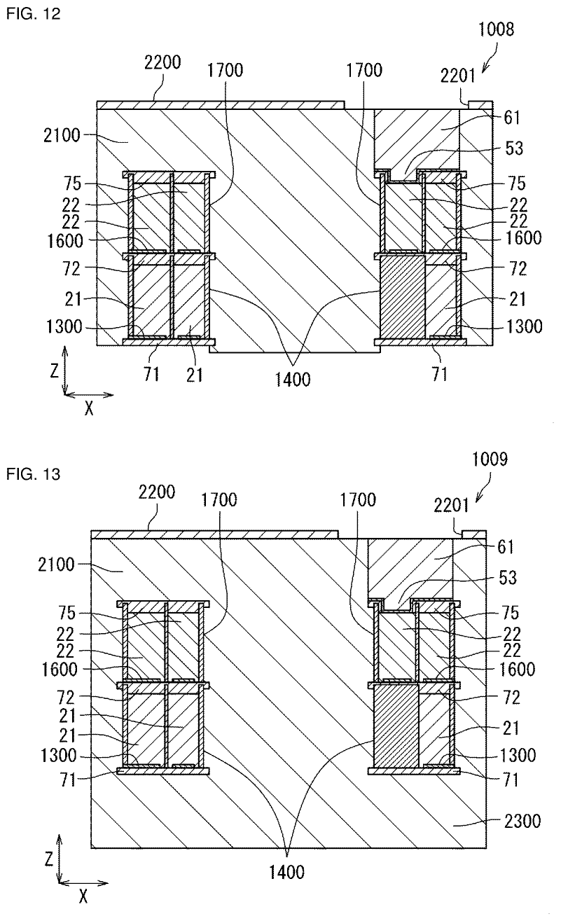

As illustrated in FIG. 12, the manufacturing apparatus removes the substrate 1000, the adhesive layer 1100, and the seed layer 1200 from the seventh multilayer body 1007 to form an eighth multilayer body 1008. The substrate 1000 and the adhesive layer 1100 are removed by, for example, mechanically peeling the adhesive layer 1100. The seed layer 1200 is removed by, for example, wet etching or polishing. In a case in which the seed layer 1200 is removed by wet etching, a part of the metal magnetic powder of the magnetic layer 2100 is etched, and a surface thereof is roughened, so that the close-contact strength with a magnetic layer 2300 formed in the next step is improved.

As illustrated in FIG. 13, the manufacturing apparatus forms the magnetic layer 2300 on the eighth multilayer body 1008 to form a ninth multilayer body 1009. The magnetic layer 2300 is formed by, for example, a step including magnetic material pressing, solidification, and grinding. Grinding is performed to adjust the thickness of the element body 2. The thickness of the element body 2 may be adjusted by adjusting an amount of pressing during the formation of the magnetic layer 2300 without performing grinding. The magnetic layer 2300 forms a part of the magnetic material 201.

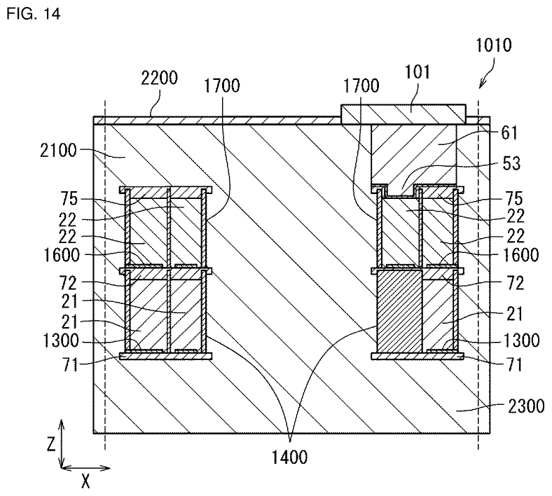

As illustrated in FIG. 14, the manufacturing apparatus forms the external terminal 101 on the ninth multilayer body 1009, forms a tenth multilayer body 1010, and then fragments the tenth multilayer body 1010 to form the inductor component 1 illustrated in FIG. 2. The external terminal 101 is formed by, for example, a step including sputtering (Cu seed), resist lamination, photolithography, electrolytic plating, resist peeling, and seed etching. The fragmentation is performed, for example, along a broken line illustrated in FIG. 14.

The exposed vertical wiring 61 may be used as the external terminal instead of forming the external terminal 101. As in the present aspect, in a case in which the configuration is adopted in which the external terminal 101 is formed in the cavity 2201 of the solder resist 2200 and is connected to the vertical wiring 61, an area of the external terminal 101 can be increased, and thus the fixation force of the inductor component 1 to another device or the like can be improved. In addition, since the external terminal 101 having any shape such as a protruding shape can be formed, the degree of freedom in a case of mounting the inductor component 1 is improved.

The external terminal 101 may be formed without forming the solder resist 2200. The external terminals 101 may be formed, for example, like the vertical wiring 61, by forming the seed layer on the entire surface and then performing electrolytic plating. In this case, the external terminal 101 has a configuration similar to a Cu bump.

The inductor component 1 can exhibit the effects described below.

The inductor component 1 includes the first inductor wiring 21, the second inductor wiring 22, and the element body 2. The first inductor wiring 21 extends along the first virtual plane S1 and extends around the first turning axis A1 along the first direction Z intersecting with the first virtual plane S1. The second inductor wiring 22 extends along the second virtual plane S2 parallel and adjacent to the first virtual plane S1 and extends around the second turning axis A2 along the first direction Z. The element body 2 includes the magnetic material 201, and the first inductor wiring 21 and the second inductor wiring 22 are located inside the element body 2. The magnetic material 201 includes the first magnetic portion 2011 that is located in a region closer to the first turning axis A1 than the first inductor wiring 21, and the second magnetic portion 2012 that is located in a region closer to the second turning axis A2 than the second inductor wiring 22. The first magnetic portion 2011 and the second magnetic portion 2012 are formed to match each other when viewed along the first direction Z. The first turning axis A1 and the second turning axis A2 are located with spacing from each other in the second direction intersecting with the first direction Z. By shifting the turning axes of the first inductor wiring 21 and the second inductor wiring 22, the magnetic paths are shared without extremely increasing the inductive coupling factor, and the filling property of the magnetic material 201 is improved. As a result, it is possible to achieve the inductor component 1 having high acquisition efficiency of the inductance. In addition, by forming an inductor array, a mounting area of the inductor component 1 can be reduced. For example, in a case in which the inductor component 1 is applied to a buck converter and the inductive coupling factor is extremely high, when a signal having an opposite phase is input between the first inductor wiring 21 and the second inductor wiring 22, a ripple current is increased, and the power conversion efficiency of the buck converter is decreased.

The first magnetic portion 2011 and the second magnetic portion 2012 are formed of a composite material of a metal magnetic alloy containing the largest amount of an iron element and an organic resin. With this configuration, the electrical characteristics of the inductor component 1 can be improved. In addition, since it is difficult for stress to be present inside the element body 2, cracks generated in the element body 2 can be reduced.

A portion of the first inductor wiring 21 to which the via 52 is connected and a portion of the second inductor wiring 22 to which the via 54 is connected are electrically isolated of each other. A portion of the first inductor wiring 21 to which the via 51 is connected and a portion of the second inductor wiring 22 to which the via 53 is connected are electrically connected to each other. With this configuration, different signals can be input to the inductor component 1, and the resistance of the inductor component 1 to breakdown due to static electricity can be improved.

The inductor component 1 includes the external terminal 101 that is provided on the main surface 202 of the element body 2, the vertical wiring 61, and the via 51 (an example of a via conductor). The vertical wiring 61 connects a portion of the second inductor wiring 22 to which the via 53 is connected and the external terminal 101 to each other. The via 51 connects a portion of the first inductor wiring 21 to which the via 51 is connected and a portion of the second inductor wiring 22 to which the via 53 is connected, to each other. With this configuration, since a bottom surface electrode structure can be adopted, the mounting area of the inductor component 1 can be further reduced. For example, a portion of the vertical wiring 61 exposed from the main surface 202 of the element body 2 may be used as the external terminal 101.

The outer shape of the first inductor wiring 21 and the outer shape of the second inductor wiring 22 match each other when viewed along the first direction Z. With this configuration, the filling with the magnetic material 201 can be easily performed during manufacturing of the inductor component 1. As a result, it is possible to achieve the inductor component 1 having high filling property of the magnetic material 201 and high acquisition efficiency of the inductance.

The turning direction of the first inductor wiring 21 extending around the first turning axis A1 is opposite to the turning direction of the second inductor wiring 22 extending around the second turning axis A2. With this configuration, the positivity and negativity of the inductive coupling factor between the first inductor wiring 21 and the second inductor wiring 22 can be controlled. By reversing the winding directions of the first inductor wiring 21 and the second inductor wiring 22, the inductive coupling factor between the first inductor wiring 21 and the second inductor wiring 22 is negative coupling. For example, in a case in which the inductor component 1 is applied to the buck converter, the ripple current can be reduced, so that the efficiency of the buck converter can be improved.

The first inductor wiring 21 has a spiral shape having the number of turns larger than one. The element body 2 has, inside, the first region B1 closer to the first turning axis A1 than the first inductor wiring 21. The first magnetic portion 2011 and the non-magnetic material 203 are located in the first region B1. The first magnetic portion 2011 is adjacent to a portion having the largest number of first inductor wirings 21 when viewed from the first turning axis A1 along the second direction. With this configuration, since the first magnetic portion 2011 is located in a region having a large magnetic flux (=region having a large number of turns of the first inductor wiring 21), the acquisition efficiency of the inductance of the inductor component 1 can be increased.

The non-magnetic material 203 includes a photosensitive insulating material. With this configuration, the non-magnetic material 203 at and the other insulating layers can be simultaneously formed, so that the manufacturing cost of the inductor component 1 can be reduced. In addition, by including the photosensitive material, a fine and high-aspect region of the non-magnetic material 203 can be formed, so that the degree of freedom in the structure of the inductor component 1 is improved.

The area of the external terminal 101 is larger than the areas of the external terminal 102 and the external terminal 103 when viewed along the first direction Z. With this configuration, the electromigration can be suppressed.

The inductor component 1 includes the first pad portion 81 that extends along the second virtual plane S2 and that is adjacent to the second inductor wiring 22 in an electrically isolated state. With this configuration, the degree of freedom in the design of the inductor component 1 can be improved. For example, the inductor component 1 including more inductor wirings can be achieved. The first pad portion 81 can be used to, for example, lead out the wiring of the lower layer to the upper layer.

The inductor component 1 can be formed as follows.

When viewed along the first direction Z, a dimension of the non-magnetic material 203 in a direction orthogonal to a direction in which the non-magnetic material 203 of the first region B1 extends is defined as a “width of the non-magnetic material 203 of the first region B1”, and a dimension of the first inductor wiring 21 in a direction orthogonal to a direction in which the first inductor wiring 21 extends is defined as a “width of the first inductor wiring 21”. The inductor component 1 may be formed such that the maximum value of the width of the non-magnetic material 203 in the first region B1 is larger than the maximum value of the width of the first inductor wiring 21. Similarly, a dimension of the non-magnetic material 203 in a direction orthogonal to the direction in which the non-magnetic material 203 of the first region C1 extends is defined as a “width of the non-magnetic material 203 of the first region C1”, and a dimension of the second inductor wiring 22 in a direction orthogonal to the direction in which the second inductor wiring 22 extends is defined as a “width of the second inductor wiring 22”. The inductor component 1 may be formed such that the maximum value of the width of the non-magnetic material 203 in the first region C1 is larger than the maximum value of the width of the second inductor wiring 22. With this configuration, the leakage between the magnetic material 201 and the first inductor wiring 21 and the second inductor wiring 22 can be suppressed. The deformation resistance of the element body 2 can be increased by increasing the non-magnetic material 203. In addition, by increasing the size of the non-magnetic material 203, the magnetism saturation is suppressed, and the direct current superimposed characteristics of the inductor component 1 can be improved.

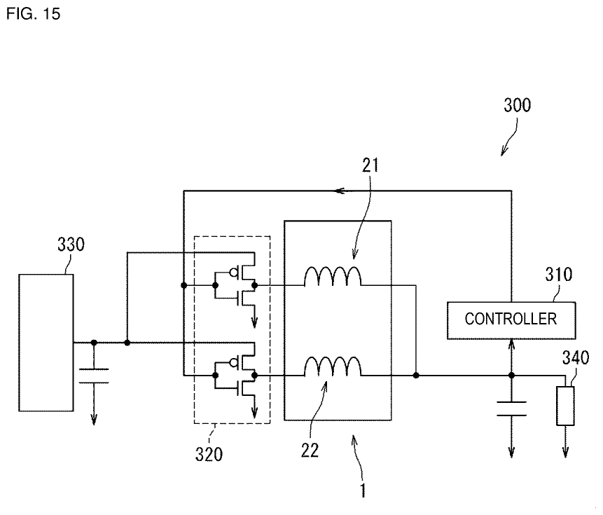

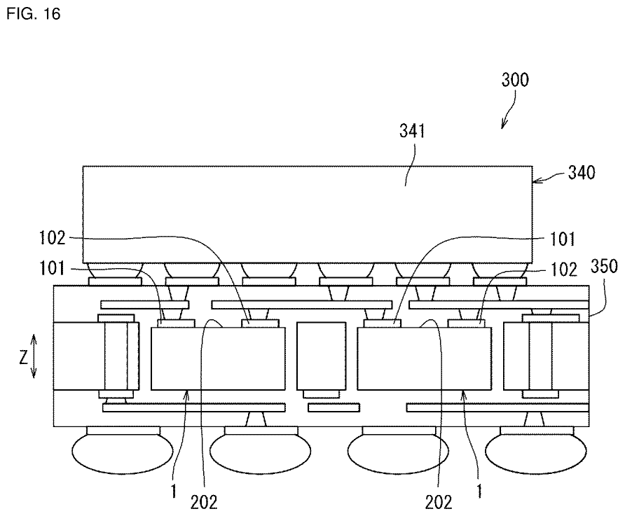

The inductor component 1 can be applied to, for example, a buck converter 300 as illustrated in FIGS. 15 and 16. As an example, as illustrated in FIG. 15, the buck converter 300 includes the inductor component 1, a controller 310, a switching element 320, a voltage regulator module (VRM) 330, and a load circuit (for example, a semiconductor integrated circuit) 340. The controller 310 controls the switching element 320 to supply the direct current converted by the VRM 330 to the inductor component 1. An output side of the inductor component 1 is connected to the controller 310 and the load circuit 340.

As illustrated in FIG. 16, the buck converter 300 includes a package substrate 350 and the inductor component 1 located inside the package substrate 350. As an example, the buck converter 300 includes two inductor components 1. The external terminals 101 to 106 of each inductor component 1 are connected to the load circuit 340 (that is, the load side). In the operation of the buck converter 300, the current is supplied to each inductor component 1 on an input side, and the current on the output side (that is, the load side) is integrated. Therefore, it is not necessary to perform wiring routing for unnecessary integration by disposing the external terminal 101, which is a common terminal, on the load side. As a result, the wiring loss of the buck converter 300 is decreased, and the power conversion efficiency of the buck converter 300 can be improved.

As an example, the package substrate 350 illustrated in FIG. 16 is formed to be connectable to a semiconductor module 341 (an example of the load circuit 340). The main surface 202 of the element body 2 (an example of an outer surface of the element body 2) in which the external terminals 101 to 106 of each inductor component 1 are provided intersects with the first direction Z and faces the semiconductor module 341 in a state in which the semiconductor module 341 is connected to the package substrate 350. In the buck converter 300 illustrated in FIG. 16, since the external terminals 101 to 106 are formed on the main surface 202 of the element body 2, a current path between the inductor component 1 and the semiconductor module 341 can be made efficient. As a result, the power loss of the buck converter 300 can be reduced.

In the buck converter 300 illustrated in FIG. 16, the inductor component 1 is located inside an outer shape of the semiconductor module 341 when viewed along the first direction Z. With this configuration, the wiring loss of the buck converter 300 can be reduced.

In the buck converter 300 illustrated in FIG. 16, each inductor component 1 is formed such that an absolute value of the inductive coupling factor between the first inductor wiring 21 and the second inductor wiring 22 is larger than an absolute value of the inductive coupling factor between the first inductor wiring 21 and the third inductor wiring 23, and is in a range of 0.2 to 0.7. In the buck converter 300 illustrated in FIG. 16, as an example, a switching frequency is 10 MHz to 100 MHz, an input voltage is 1.8 V to 20 V, and an output voltage is 0.5 V to 1.0 V. As a result, the ripple current of each inductor component 1 can be suppressed. In addition, since the frequency on the output side of each inductor component 1 is apparently doubled, it is possible to achieve the buck converter 300 having high power conversion efficiency and responsiveness.

In a case in which the absolute value of the inductive coupling factor between the first inductor wiring 21 and the second inductor wiring 22 is smaller than 0.2, the plurality of inductor wirings are simply arranged, and the above-described effects cannot be obtained. In a case in which the absolute value of the inductive coupling factor between the first inductor wiring 21 and the second inductor wiring 22 is larger than 0.7, a duty ratio (Vout (output voltage)/Vin (input voltage)) is limited. As the duty ratio is larger than 0.7, the power conversion efficiency of the buck converter 300 is decreased.

For example, by setting the inductive coupling factor between the first inductor wiring 21 and the second inductor wiring 22 to the negative coupling, the responsiveness of the buck converter 300 can be further improved. In a case in which a semiconductor switch is used as the switching element, a withstand voltage of the semiconductor switch can be increased by decreasing the switching frequency, and thus the input voltage to the inductor component 1 can be increased. In a case in which the switching frequency is increased, the responsiveness of the voltage to the load variation of the inductor component 1 can be improved. In a case in which the switching frequency is higher than 100 MHz, the switching loss is increased.

The inductor component 1 may include a conductor layer that is located on each of three or more virtual planes parallel to each other, and an inductor wiring that is provided on each conductor layer. That is, the inductor component 1 may include three or more layers of inductor wirings.

The inductor component 1 may be formed such that only the first conductor layer 11 is located on the first virtual plane S1, or the inductor component 1 may be formed such that three or more conductor layers including the first conductor layer 11 and the third conductor layer 13 are located. Similarly, the inductor component 1 may be formed such that only the second conductor layer 12 is located on the second virtual plane S2, or the inductor component 1 may be formed such that three or more conductor layers including the second conductor layer 12 and the fourth conductor layer 14 are located.

The angle formed by the first virtual straight line L1 and the second virtual straight line L2 is not limited to an angle of 80 degrees to 110 degrees, and may be another angle.

The conductor layer (for example, the first conductor layer 11, the second conductor layer 12, the third conductor layer 13, and the fourth conductor layer 14), the insulating layer (for example, the insulating layer 71, the insulating layer 72, the insulating layer 73, and the insulating layer 74), the vertical wiring 61, and the vias 51, 52, 53, 54, and 55, which are located inside the element body 2, may be omitted depending on the design of the inductor component 1 and the like.

The shape and the size of each part forming the inductor component 1 are not limited to the above-described aspect, and can be optionally set depending on the design of the inductor component 1 and the like. For example, the thickness of the first conductor layer 11 of the inductor component 1 is not limited to being smaller than 1.0 μm and smaller than 1/100 of the thickness of the first inductor wiring.

A portion of the first inductor wiring 21 to which the via 51 is connected may form an input portion, and a portion to which the via 52 is connected may form an output portion. A portion of the second inductor wiring 22 to which the via 53 is connected may form an input portion, and a portion to which the via 54 is connected may form an output portion.

Each inductor wiring need only have a spiral shape when viewed along the first direction Z. For example, each inductor wiring may be a curve having the number of turns (turn count) equal to or larger than one, or may be a curve having the number of turns of smaller than one. Each inductor wiring may have a linear shape in a part thereof.

In the embodiments and modification examples of the present disclosure, a combination of the embodiments, a combination of the modification examples, or a combination of the embodiments and the modification examples can be made. The features included in the embodiments and modification examples of the present disclosure can also be combined.

The details of the configuration of the present disclosure may be changed, and a combination of the elements or a change in order in each embodiment can be achieved without departing from the scope and idea of the present disclosure.

What is claimed is:

1. An inductor component comprising:
a first inductor wiring that extends along a first virtual plane and that extends around a first turning axis along a first direction intersecting with the first virtual plane;
a second inductor wiring that extends along a second virtual plane parallel and adjacent to the first virtual plane and that extends around a second turning axis along the first direction; and
an element body that includes a magnetic material, and the first inductor wiring and the second inductor wiring,
wherein the magnetic material includes
a first magnetic portion that is in a region closer to the first turning axis than the first inductor wiring, and
a second magnetic portion that is in a region closer to the second turning axis than the second inductor wiring,
the first magnetic portion and the second magnetic portion are configured to match each other when viewed along the first direction, and
the first turning axis and the second turning axis are spaced from each other in a second direction intersecting with the first direction.

2. The inductor component according to claim 1, wherein
the first magnetic portion and the second magnetic portion include a composite material of a metal magnetic alloy including a largest amount of an iron element and an organic resin.

3. The inductor component according to claim 1, wherein
in a case in which both ends of the first inductor wiring in a direction in which the first inductor wiring extends are defined as a first end portion and a second end portion, and both ends of the second inductor wiring in a direction in which the second inductor wiring extends are defined as a third end portion and a fourth end portion,
the first end portion and the third end portion are electrically isolated from each other, and the second end portion and the fourth end portion are electrically connected to each other.

4. The inductor component according to claim 3, further comprising:
an external terminal that is on an outer surface of the element body intersecting with the first direction;
a vertical wiring that connects the fourth end portion and the external terminal to each other; and
a via conductor that connects the second end portion and the fourth end portion to each other.

5. The inductor component according to claim 1, wherein
an outer shape of the first inductor wiring and an outer shape of the second inductor wiring match each other when viewed along the first direction.

6. The inductor component according to claim 1, wherein
a turning direction of the first inductor wiring extending around the first turning axis is opposite to a turning direction of the second inductor wiring extending around the second turning axis.

7. The inductor component according to claim 1, wherein
the first inductor wiring has a spiral shape having a number of turns larger than one,
the element body has, inside, a first region closer to the first turning axis than the first inductor wiring,
the first magnetic portion and a non-magnetic material are in the first region, and
the first magnetic portion is adjacent to a portion including a largest number of the first inductor wirings when viewed along the second direction from the first turning axis.

8. The inductor component according to claim 7, wherein
the non-magnetic material includes a photosensitive insulating material.

9. The inductor component according to claim 7, wherein
the non-magnetic material extends along the first inductor wiring, and
in a case in which, when viewed along the first direction, a dimension of the non-magnetic material in a direction orthogonal to a direction in which the non-magnetic material extends is defined as a width of the non-magnetic material, and a dimension of the first inductor wiring in a direction orthogonal to a direction in which the first inductor wiring extends is defined as a width of the first inductor wiring,
a maximum value of the width of the non-magnetic material is larger than a maximum value of the width of the first inductor wiring.

10. The inductor component according to claim 3, further comprising:
a first external terminal, a second external terminal, and a third external terminal that are each on an outer surface of the element body intersecting with the first direction,
wherein
the first external terminal is electrically connected to the first end portion,
the second external terminal is electrically connected to the second end portion and the fourth end portion,
the third external terminal is electrically connected to the third end portion, and
an area of the second external terminal is larger than areas of the first external terminal and the third external terminal when viewed along the first direction.

11. The inductor component according to claim 1, further comprising:
a first pad portion that extends along the second virtual plane and that is adjacent to the second inductor wiring in an electrically isolated state.

12. A buck converter comprising:
a package substrate; and
the inductor component according to claim 3 that is inside the package substrate,
wherein the second end portion and the fourth end portion are configured to be connected to a load side.

13. A buck converter comprising:
a package substrate configured to be connectable to a semiconductor module; and
the inductor component according to claim 1 that is inside the package substrate,
wherein the inductor component includes an external terminal that is on an outer surface of the element body intersecting with the first direction and facing the semiconductor module, in a state in which the semiconductor module is connected to the package substrate.

14. A buck converter comprising:
a package substrate; and
the inductor component according to claim 1 that is inside the package substrate,
wherein
the inductor component includes a third inductor wiring that extends along the first virtual plane and that is spaced from the first inductor wiring in the second direction, and
an absolute value of inductive coupling factor between the first inductor wiring and the second inductor wiring is larger than an absolute value of inductive coupling factor between the first inductor wiring and the third inductor wiring and is in a range of 0.2 to 0.7.

15. The buck converter according to claim 13, wherein
the inductor component is inside an outer shape of the semiconductor module when viewed along the first direction.

16. The inductor component according to claim 2, wherein
in a case in which both ends of the first inductor wiring in a direction in which the first inductor wiring extends are defined as a first end portion and a second end portion, and both ends of the second inductor wiring in a direction in which the second inductor wiring extends are defined as a third end portion and a fourth end portion,
the first end portion and the third end portion are electrically isolated from each other, and the second end portion and the fourth end portion are electrically connected to each other.

17. The inductor component according to claim 2, wherein
an outer shape of the first inductor wiring and an outer shape of the second inductor wiring match each other when viewed along the first direction.

18. The inductor component according to claim 2, wherein
a turning direction of the first inductor wiring extending around the first turning axis is opposite to a turning direction of the second inductor wiring extending around the second turning axis.

19. The inductor component according to claim 2, wherein
the first inductor wiring has a spiral shape having a number of turns larger than one,
the element body has, inside, a first region closer to the first turning axis than the first inductor wiring,
the first magnetic portion and a non-magnetic material are in the first region, and
the first magnetic portion is adjacent to a portion including a largest number of the first inductor wirings when viewed along the second direction from the first turning axis.

20. The inductor component according to claim 2, further comprising:
a first pad portion that extends along the second virtual plane and that is adjacent to the second inductor wiring in an electrically isolated state.
